(19) United States
(12) Patent Application Publication
(10) Pub. No.: US 2021/0194088 A1
(43) Pub. Date: Jun. 24, 2021

(54) FIRE RESISTANT SMC LAMINATE

(71) Applicants: Jeffrey R. ROBBINS, Ann Arbor, MI (US); Magna Exteriors Inc., Concord (CA)

(72) Inventors: Jeffrey R. Robbins, Ann Arbor, MI (US); Ranjit Pachha, Brampton (CA)

(73) Assignee: Magna Exteriors Inc., Concord, ON (CA)

(21) Appl. No.: 17/252,835

(22) PCT Filed: Jul. 11, 2019
(86) PCT No.: PCT/US2019/041385

§ 371 Date: Dec. 16, 2020

Related U.S. Application Data
(60) Provisional application No. 62/696,612, filed on Jul. 11, 2018.
(60) Provisional application No. 62/696,608, filed on Jul. 11, 2018.

(51) Int. Cl. H01M 50/231; H01M 50/24; H01M 50/249; H01M 50/244; B32B 7/12; B32B 5/02; B32B 27/08; B32B 27/20

(52) U.S. Cl. CPC H01M 50/231; H01M 50/24; H01M 50/249; H01M 50/244; B32B 7/12; B32B 2457/10; B32B 27/08; B32B 27/20; H01M 2220/20; B32B 2307/3065; B32B 5/024

(57) ABSTRACT

A flame retardant SMC laminate composition comprising a layer of and effective amount of flame retardant material attached to a layer of an SMC composition for providing a flame retardant moldable laminate.

### FIELD OF THE INVENTION

The present invention relates to light weight fire resistant SMC laminate composition.

### BACKGROUND OF THE INVENTION

Sheet molding compositions are useful as housings and bodies of many items. Furnaces, vehicle panels and consumer goods are made from such compositions. Flammability of in home environments have been subject to many regulations and materials which have been developed to reduce flammability of such items. It has been found that aluminum trihydrate (ATH) is added as a filler in relatively high concentrations for controlling flammability of such SMC structures.

With the advent of electric vehicles, banks of batteries are required for powering the vehicles. The batteries are required to be housed in a box or some sort of container within the vehicle. Typically a light aluminum material is used because it does not burn. However, aluminum does get brittle after a raised temperature event and does have a fairly low melting point and cannot withstand temperatures over 680 degrees Centigrade plus these materials are conductive and as such are not the best selection for batteries storing electricity potential. Thus, using a material such as an SMC material as a substitute is desirable.

There has been a new standard created which any material used in a vehicle must maintain. Currently the material must withstand minimal burning for 130 seconds when subjected to a gasoline fire of 960 degrees Centigrade. SMC when highly loaded with ATH can withstand this flammability test. However, materials with the proper amount of ATH become heavy typically above specific gravity of 2. Plus, the high quantities of ATH required to meet the proper standard reduces the mechanical properties of the SMC enough to make it prohibitive to manufacture and use.

Therefore it is a desired to provide a relatively light weight SMC composition useful in flame retardant applications such as a battery box of an electric vehicle.

### SUMMARY OF THE INVENTION

In accordance with the present invention there is provided a flame retardant SMC laminate composition comprising: a layer of and effective amount of flame retardant material attached to a layer of an SMC composition for providing a flame retardant moldable laminate.

A layer of effective flame retardant material is comolded, overmolded or adhesively joined with SMC providing a flame retardant moldable laminate. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a line useful for manufacturing the present SMC composition;

FIG. 2 is a cross-sectional view of a fire retardant SMC Laminate in accordance with the teachings of the present invention; and,

FIG. 3 is an illustrative view of a typical SMC molding process for molding of the laminates into a final part.

### DETAILED DESCRIPTION OF THE PREFERRED EMBODIMENTS

The following description of the preferred embodiment(s) is merely exemplary in nature and is in no way intended to limit the invention, its application, or uses.

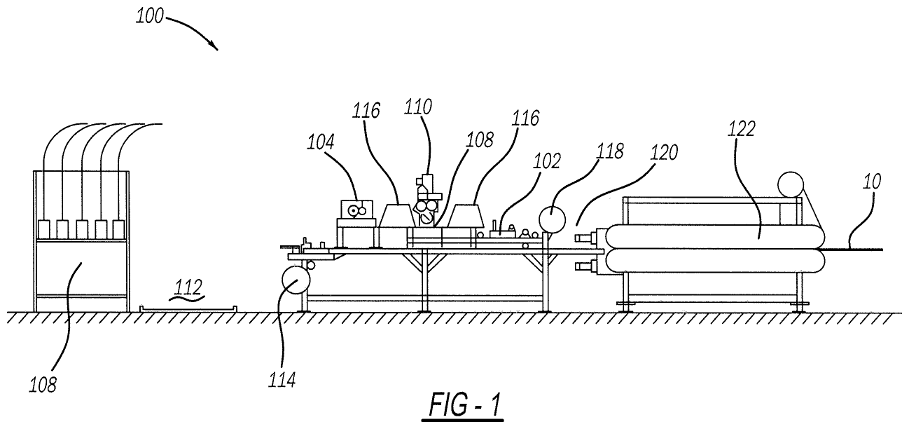

Referring to FIG. 1 there is shown a typical compounding line layout which is useful in preparing the flame retardant laminates of the present application. The compounding layout shown generally at 100 in FIG. 1. The line shown is for compounding a glass and carbon fiber reinforced SMC laminate and can be used for addition of the flame retardant material at the doctor box 102. It will be readily appreciated by those skilled in the art that the flame retardant materials could also be added elsewhere or mixed in with the carbon fiber or glass fillers as they are chopped and cut in the glass cut box 104 or carbon cut box 106. The laminate line as an example includes a carbon creel 108 which is connected to the compressed air and carbon fiber inlet 110. A space for a glass fiber creel is also provided at 112 for glass reinforcement as necessary. A first film unwind is provided at 114 and vacuum exhausts at 116. A second film unwind is provided at 118. There is a pre-compactor and de-aeration chamber provided at 120 prior to the laminate entering the compactor 122. The final SMC fire retardant laminate 10 exits the compounding line and is wound on an automatic winder. As will be appreciated the entire line is temperature controlled during the compounding process.

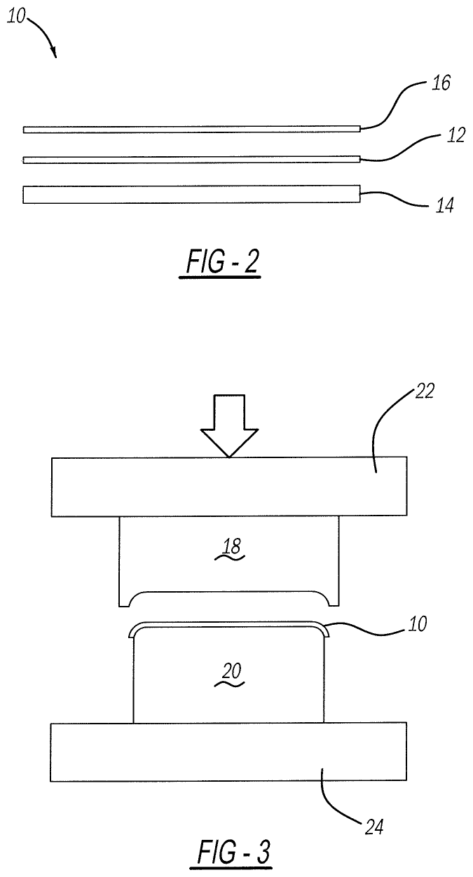

Referring now to the drawings and in particular to FIG. 2, in accordance with the present invention there is provided a flame retardant SMC laminate composition generally shown at 10. The SMC laminate of the present invention includes at least a layer of an effective amount of flame retardant material 12 attached to at least one layer of an SMC composition 14 for providing a flame retardant moldable laminate. Preferably the resulting laminate has a specific gravity of less than or equal to 1.8 and can withstand the ASTM E-84 standards for flame retardancy. In the embodiment shown a further protective layer of SMC 16 is used to sandwich the flame retardant material 12 in between a structural SMC layer 14 and protective layer 16.

The layer of effective amount of flame retardant material 12 is selected from the group comprising a graphene containing SMC material, a woven graphene embedded mat material, an intumescent material, a nomex material, a broad mix Aramid (aromatic polyamide) material and mixtures thereof. Using the laminate production line. Typically, these materials are assembled using woven mats of materials. However, individually laid fibers, chopped fibers, powders and pulps of these materials are also used in alternate embodiments. A layer of effective flame retardant material comolded, overmolded or adhesively joined with SMC providing a flame retardant moldable laminate. Preferably the resulting laminate has a specific gravity of less than or equal to 1.8 and can withstand the ASTM E-84 standards for flame retardancy.

With respect to an aramid layer for providing fire retardancy a layer 12 of from about 25 micron to about 1.0 mm of aramid is used in the present invention which is sandwiched between an about 1 to about 1.5 mm thick SMC layer 16 with a structural layer 14 of SMC of from about 2.5 to about 4.0 mm thick SMC.

In a second embodiment and intumescent material is used as a fire retardant layer 12. In this embodiment a layer of from about .35 mm to about 2.2 mm (prior to char expansion) is used for providing the requisite fire retardancy layer 12. This material is selected such that at a temperature of 190 to 220 degrees Centigrade the intumescent material expands exponentially into its insulating char layer form for providing flame retardancy by this method.

In a particularly preferred laminate a layer of a graphene containing light weight fire retardant material having the following composition may be applied to a standard SMC composition or sandwiched between SMC layers 14 and 16. Alternatively this material is optionally used as either layer 14 or 16 or as layer 12 in the present laminate invention. With respect to a flame resistant graphene containing layer the particular embodiment of this layer is as follows.

The effective amount of graphene material is provided in said SMC in an amount of from about 0.1% to about 10% by volume in the SMC with the remainder SMC fillers and reinforcement elements. Preferably the graphene is provided in an amount of from about 0.2% to about 5% by volume.

SMC compositions useful in the present invention are preferably a vinyl ester based SMC which are long glass fiber reinforced with .5 to 1.5 inch glass fibers and preferably about 1 inch glass fibers. Generally the SMC includes 20%-30% glass fibers and typically about 25% to about 28% glass fibers. However, unsaturated polyesters, phenolics, polyurethanes and epoxy resins can also be used.

It is within the scope of the present invention that ATH is to be included in the composition provided handling and mechanical properties of the SMC resin may be maintained and provided the resulting composition maintains a specific gravity of less than or equal to 1.8.

The graphene may or may not be functionalized. Graphene having functional groups like COOH (carboxyl) may be used to achieve chemical bonding with the resin resulting in better mechanical properties of the sheet molding composition (SMC). The SMC materials of the present invention comply with the ASTM E-84 standards for flame retardancy and are also able to withstand the gasoline burn tests of withstanding 960 degrees Centigrade for 130 seconds.

SMC compositions are useful for battery boxes in an electric vehicle in that even if exposed to a fire, properties are maintained and useful life remains. This is an improvement over aluminum boxes where if exposed to high heat they may either melt away or mechanical properties are severely diminished requiring replacement.

Referring now to FIG. 3, in accordance with the process aspects of this invention. The laminate is placed in a suitable mold which includes a cavity 18 and a core 20 which is positioned between platens 22 and 24. The cavity is typically heated to from about 135 to 150 degrees Centigrade with the core about 5 degrees cooler and the SMC is molded at a pressure of from about 65 to about 75 Bar for a sufficient time for curing of the SMC material used.

### Example 1

The layers of effective amount of flame retardant material are made from a graphene containing SMC material, a woven graphene embedded mat material, an intumescent material, a nomex material, a broad mix Aramid (aromatic polyamide) material and mixtures thereof. Using the laminate production line. These materials are assembled using woven mats of materials between SMC layers and also as a separate layer. Individually laid fibers, chopped fibers, powders and pulps of these materials are also used.

With respect to an aramid layer for providing fire retardancy a layer of from about 25 micron to about 1.0 mm of aramid is used which is sandwiched between an about 1 to about 1.5 mm thick SMC layer 16 with a structural layer 14 of SMC of from about 2.5 to about 4.0 mm thick SMC.

The SMC and materials manufactured are found to comply with the ASTM E-84 standards for flame retardancy.

### Example 2

In a second embodiment an intumescent material is used as a fire retardant layer. In this embodiment a layer of from about 0.35 mm, 1.0, 1.5 mm and 2.2 mm (prior to char expansion) are used for providing the requisite fire retardancy layer. This material is selected such that at a temperature of 190 to 220 degrees Centigrade the intumescent material expands exponentially into its insulating char layer form for providing flame retardancy by this method. This material is tested and meets the ASTM E-84 Standards for flame retardancy

### Example 3

A laminate layer of a graphene containing light weight fire retardant material is prepared using 0.1%, 0.2%, 5.0%, 10% by volume graphene with the balance SMC and fillers. This layer is applied to a standard SMC composition and also sandwiched between SMC layers. The compound is found to be flame retardant as required by the ASTM E-84 standards for flame retardancy.

SMC compositions used are vinyl ester based SMC's which are long glass fiber reinforced with 0.5, 1, and 1.5 inch glass fibers. The SMC's used include 20%, 25%, 28% and 30% glass fibers. Tests are made using unsaturated polyesters and epoxy resins also in the above amounts with and without fillers. This material is tested and meets the ASTM E-84 Standards for flame retardancy

The description of the invention is merely exemplary in nature and, thus, variations that do not depart from the essence of the invention are intended to be within the scope of the invention. Such variations are not to be regarded as a departure from the spirit and scope of the invention.

Further understanding of flame retardant SMC laminates will be acquired in reference to my co-pending application filed on the same date as this application entitled “LIGHT WEIGHT FIRE RESISTANT SMC COMPOSITION”, claiming priority to U.S. Provisional Ser. No. 62/696,608, filed Jul. 11, 2018, Attorney Docket No. DEC-00367-PCA (711377PCT), the entire contents of which are expressly incorporated by reference herein.

What is claimed is:

1. A flame retardant SMC laminate composition comprising:
a layer of an effective amount of flame retardant material comolded, overmolded or adhesively joined with an SMC composition for providing a flame retardant moldable laminate.

2. The flame retardant SMC laminate composition of claim 1 wherein the layer of effective amount of flame retardant material is selected from the group comprising a graphene containing SMC material, a woven graphene embedded mat material, an intumescent material, a nomex material, a broad mix Aramid material and mixtures thereof.

3. The flame retardant SMC laminate composition of claim 2 wherein the layer of an effective amount of the flame retardant material is sandwiched between layers of a moldable SMC material.

4. The flame retardant SMC laminate composition of claim 1 wherein the material complies with the ASTM E-84 standards for flame retardancy.

5. The flame retardant SMC laminate composition of claim 1 wherein the effective amount of graphene material is provided in said SMC in an amount of from about 0.1% to about 10% by volume in the SMC with the remainder SMC.

6. The flame retardant SMC laminate composition of claim 3 wherein the graphene is provided in an amount of from about 0.2% to about 5% by volume.

7. The flame retardant SMC laminate composition of claim 4 wherein the graphene includes COOH (carboxyl) functional groups which provides mechanical strengthening of the SMC

8. A battery box of an electric vehicle comprising an enclosure for containing an electric vehicle battery wherein at least a portion of the battery box includes a flame retardant SMC composition comprising:
a layer of an effective amount of flame retardant material attached to a layer of an SMC composition for providing a flame retardant moldable laminate.

9. The battery box of an electric vehicle of claim 8 wherein the layer of effective amount of flame retardant material is selected from the group comprising:
a graphene containing SMC material, a woven graphene embedded mat material, an intumescent material, a nomex material, a broad mix Aramid material and mixtures thereof.

10. The battery box of an electric vehicle composition of claim 9 wherein the layer of an effective amount of the flame retardant material is sandwiched between layers of a moldable SMC material.

11. The battery box of an electric vehicle of claim 8 wherein the material complies with the ASTM E-84 standards for flame retardancy.

12. The battery box of an electric vehicle of claim 8 wherein the effective amount of graphene material is provided in said SMC in an amount of from about 0.1% to about 10% by volume in the SMC with the remainder SMC.

13. The battery box of an electric vehicle of claim 10 wherein the graphene is provided in an amount of from about 0.2% to about 5.0% by volume.

14. The battery box of an electric vehicle of claim 11 wherein the graphene includes COOH (carboxyl) functional groups which provides mechanical strengthening of the SMC

15. A process for forming a flame retardant part comprising the steps of preparation of an SMC laminate material composition comprising:
a layer of an effective amount of flame retardant material comolded, overmolded or adhesively joined with SMC an SMC composition for providing a flame retardant moldable laminate; and,
molding a flame resistant part from said SMC laminate material composition.

16. The process according to claim 15 wherein the part comprises at least a portion of a battery box of an electric vehicle.

17. The process according to claim 16 wherein the layer of an effective amount of the flame retardant material is sandwiched between layers of a moldable SMC material.

18. The process according to claim 16 wherein the layer of effective amount of flame retardant material is selected from the group comprising a graphene containing SMC material, a woven graphene mat material, an intumescent material, a nomex material, a broad mix Aramid material and mixtures thereof.

19. The process of claim 15 wherein the material complies with the ASTM E-84 standards for flame retardancy.

20. The process of claim 15 wherein the effective amount of graphene material is provided in said SMC in an amount of from about 0.1% to about 10% by volume in the SMC with the remainder SMC.

21. The process of claim 20 wherein the graphene includes COOH (carboxyl) functional groups which provides mechanical strengthening of the SMC.

22. The process of claim 15 wherein the graphene is provided in an amount of from about 0.2% to about 5.0% by volume.
